(19) United States
(12) Patent Application Publication
(10) Pub. No.: US 2005/0112952 A1
(43) Pub. Date: May 26, 2005

(54) Power jack connector

(76) Inventors: Ning Wang, Kunsan (CN); Zhi-Qiang Chen, Kunsan (CN)

Correspondence Address: WEI TE CHUNG;FOXCONN INTERNATIONAL, INC., 1650 MEMOREX DRIVE, SANTA CLARA, CA, 95050, US

(21) Appl. No.: 10/993,891

(22) Filed: Nov. 19, 2004

(30) Foreign Application Priority Data
Nov. 21, 2003 (CN) 200320119932.5

(51) Int. Cl. H01R 24/00

(52) U.S. Cl. 439/660

(57) ABSTRACT

An electrical connector (1) includes a dielectric housing (10), a number of contacts (30) and a shell (20) enclosing the dielectric housing. The dielectric housing defines a number of passageways (14) for receiving the contacts. The contacts comprise a signal contact (31) and two pairs of power contacts (32, 33). The signal contact is attached to a center of the dielectric housing and the power contacts are symmetrically arranged around the signal contact. In such a manner, the electrical connector can transmit the signal and power simultaneously and can blind-mate with a complementary connector without regarding the orientation of the complementary connector.

### BACKGROUND OF THE INVENTION

1. Field of the Invention

The present invention relates to an electrical connector, and more particularly to a power jack connector.

2. Description of Related Art

A power jack connector commonly has one end electrically connecting with a printed circuit board and another end engaging with a power plug connector. In application, a complementary power plug connector might unintentionally insert into the power jack connector inversely. Obviously, an incorrect insertion to the power jack connector will damage the terminals within the power jack connector and result in poor electrical connection between the mated connectors.

Hence, an electrical connector having blind-mating function is desired to overcome the disadvantage of the related art.

### SUMMARY OF THE INVENTION

An object of the present invention is to provide a power jack connector which can transmit the signal and power simultaneously and have blind-mating function.

To achieve the above object, an electrical connector comprises a dielectric housing, a plurality of contacts and a shell enclosing the dielectric housing. The dielectric housing comprises a plurality of passageways for receiving the contacts therein. The contacts comprise a signal contact and a plurality of power contacts. The signal contact is attached to a center of the dielectric housing and the power contacts are symmetrically arranged around the signal contact.

Other objects, advantages and novel features of the invention will become more apparent from the following detailed description when taken in conjunction with the accompanying drawings.

### BRIEF DESCRIPTION OF THE DRAWINGS

FIG. 1 is a perspective view of an electrical connector in accordance with the present invention;

FIG. 2 is an exploded, perspective view of the electrical connector shown in FIG. 1;

FIG. 3 is a perspective view of a dielectric housing of the electrical connector; and

FIG. 4 is a view similar to FIG. 1 while taken from another aspect.

### DETAILED DESCRIPTION OF THE PREFERRED EMBODIMENT

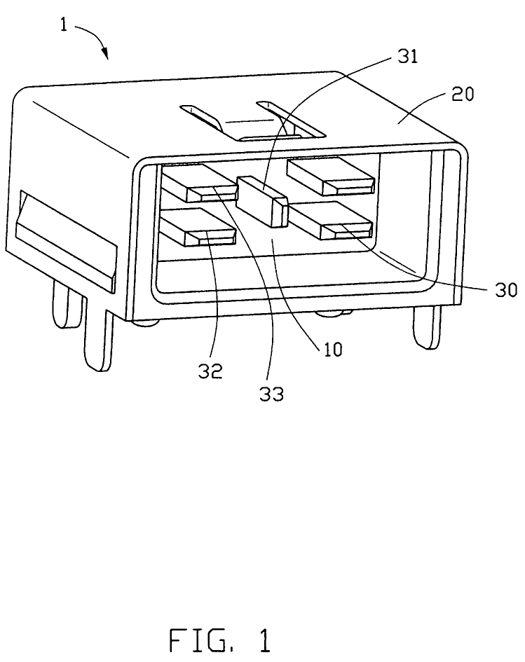

As shown in FIG. 1, an electrical connector 1 in accordance with the present invention comprises a dielectric housing 10, a plurality of contacts 30 accommodated in the dielectric housing 10, and a shell 20 enclosing the dielectric housing 10.

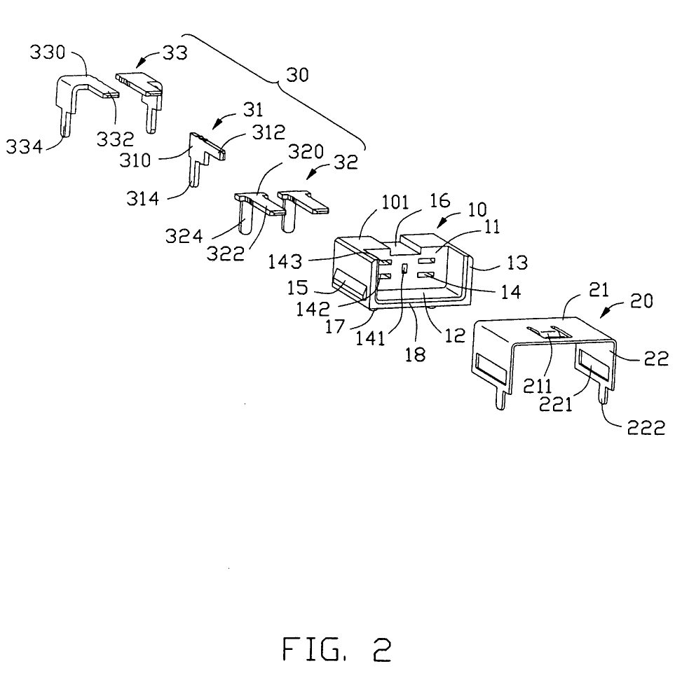

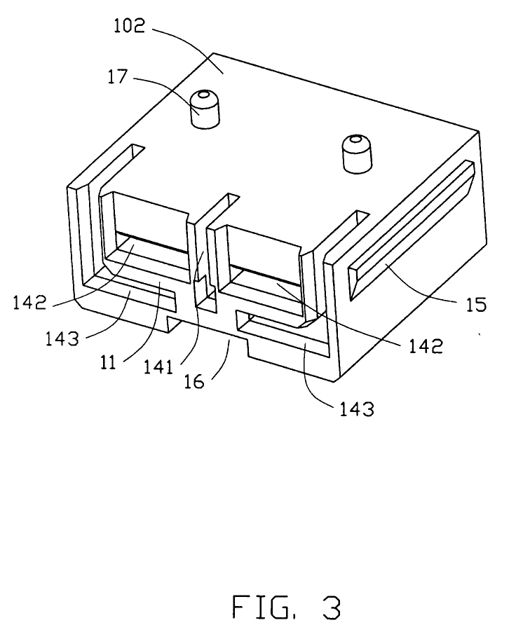

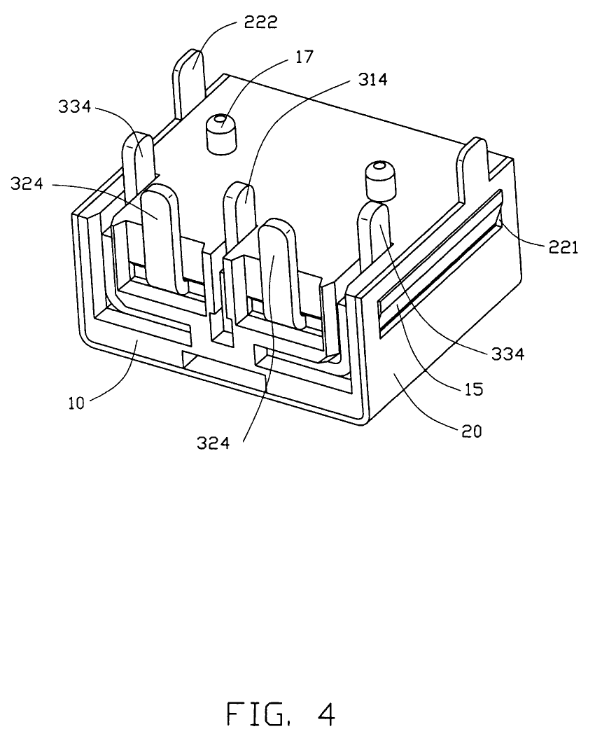

Referring to FIGS. 2-4, the dielectric housing 10 comprises a pair of parallel extending side walls 13, a bottom wall 18 connecting and extending between the side walls 13, and a plurality of passageways 14 extending therethrough. The passageways 14 comprise a first passage 141, a pair of second passages 142 and a pair of third passages 143. The second passages 142 and the third passages 143 are arrayed in two parallel rows, which will be detailedly described hereinafter. The first passage 141 is disposed at a center of the dielectric housing 10 with the second and third passages 142, 143 being symmetrically arranged at opposite sides thereof. The second passages 142 are disposed at opposite lower sides of the dielectric housing 20. The third passages 143 are disposed in positions corresponding to the second passages 142 while at opposite upper sides of the dielectric housing 20. A pair of wedged protrusions 15 are formed at outer surfaces of the sidewalls 13. A recess 16 is defined on a top face 101 of the dielectric housing 20 and parallel to the passageways 14. A pair of positioning posts 17 project downwardly from a bottom face 102 of the dielectric housing 20. The dielectric housing 20 defines a receiving space 12 in a front side to accommodate a complementary connector (not shown).

The shell 20 comprises a top wall 21 and a pair of arm portions 22 projecting downwardly from opposite edges of the top wall 21. Each arm portion 22 has an opening 221 for receiving the wedged protrusion 15 of the dielectric housing 20, and an end piece 222 extending beyond the bottom face 102 of the dielectric housing 20. A resilient tab 211 is stamped on the top wall 21 of the shell 20 and projects into the receiving space 12 of the dielectric housing 20.

The contacts 30 are received in corresponding passageways 14 of the dielectric housing 20 and comprise a signal contact 31 and two pairs of power contacts 32, 33. Each contact 30 comprises a contacting portion 312, 322, 332 extending into the receiving space 12 and shielded in the shell 20, a retention portion 310, 320, 330 fixed within the dielectric housing 20 and a tail portion 314, 324, 334 projecting beyond the bottom face 102 of the dielectric housing 20 for soldering to a printed circuit board (not shown). The contacting portion 312, the retention portion 310 and the tail portion 314 of the signal contact 31 are coplanar with each other. The contacting portions 322, 332 and the retention portions 320, 330 of the power contacts 32, 33 are also coplanar with each other, respectively. The tail portions 324 of the power contacts 32 are perpendicularly bent from corresponding retention portions 320. The tail portions 334 of the power contacts 33 are perpendicularly and transversely bent from the corresponding retention portions 330. The signal contact 31 is received in the first passage 141, and the power contacts 32, 33 are received in the second and third passages 142, 143. Thus, the signal contact 31 is disposed at the center of the dielectric housing 20 with the power contacts 32, 33 being symmetrically disposed at opposite sides thereof.

In this manner, when the electrical connector 1 is mating with the complementary connector, only one side of power contacts 32, 33 and signal contact 31 electrically connect with corresponding portions of the complementary connector. Similarly, when the complementary connector inserts into the electrical connector 1 inversely, the other side of power contacts 32, 33 are in use. As the signal contact 31 is disposed at the center, the signal contact 31 is always on working condition. Therefore, the electrical connector 1 has blind-mating function and can transmit signal and power simultaneously.

It is noted that, in other embodiments, the electrical connector might disposed more than one signal contact in any other positions. But it is necessary to dispose each signal contact at a center of centrosymmetrically disposed power contacts. Such electrical connector has blind-mating function and can transmit signal and power simultaneously, too.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

1. An electrical connector for mating with a complementary connector, comprising:
a dielectric housing comprising a plurality of passageways therein;
a plurality of contacts received in corresponding passageways and comprising at least one signal contact and a plurality of power contacts, the power contacts being centrosymmetrically disposed and the at least one signal contact being disposed at a center of centrosymmetrically disposed power contacts; and
a shell enclosing the dielectric housing.

2. The electrical connector as claimed in claim 1, wherein the at least one signal contact is disposed at a center of the dielectric housing.

3. The electrical connector as claimed in claim 1, wherein each contact comprises a contacting portion, a retention portion fixed within the dielectric housing and a tail portion extending out of the dielectric housing.

4. The electrical connector as claimed in claim 3, wherein the contact portion, the retention portion and the tail portion of the at least one signal contact are coplanar with each other, and the contact portion and the retention portion of the power contact are coplanar with each other while the tail portion thereof perpendicularly extends from the retention portion.

5. The electrical connector as claimed in claim 1, wherein the electrical connector comprises two pairs of power contacts, the two pairs of power contacts having different structures.

6. The electrical connector as claimed in claim 1, wherein the dielectric housing comprises a pair of side walls and a bottom wall connecting the side walls, the side walls and the bottom wall defining a receiving space to accommodate the complementary connector.

7. The electrical connector as claimed in claim 6, wherein each side wall of the dielectric housing has a wedged protrusion, and the shell has a pair of openings for receiving corresponding wedged protrusions.

8. The electrical connector as claimed in claim 7, wherein the shell has a resilient tab formed on a top wall thereof projecting into the receiving space of the dielectric housing.

9. The electrical connector as claimed in claim 8, wherein the dielectric housing has a pair of positioning posts projecting downwardly from a bottom face thereof.

10. The electrical connector as claimed in claim 9, wherein the dielectric housing defines a recess on a top face thereof.

11. An electrical connector comprising:
an insulative housing defining a rectangular mating cavity for allow a complementary connector coupled thereto in two opposite orientations;
at least one pair of power contacts and at least one signal contacts disposed in the housing and with respective mating portions extending into the mating cavity; wherein
said at least one signal contact is located in a center position in the mating cavity, and said power contacts spatially surrounds said signal contact in a symmetrical manner with regard to said signal contact.

12. The electrical connector as claimed in claim 11, wherein the mating portion of said signal contact defines a plane, and the mating portion of each of said power contacts defines another plane perpendicular to said plane.

13. The electrical connector as claimed in claim 11, wherein said rectangular mating cavity defines a long side and a short side perpendicular to each other, and said plane is parallel to the short side.

14. The electrical connector as claimed in claim 11, wherein each of said signal and power contacts defines a tail section, and the tail section of the signal contact defines a plane and that of one of said pair of power contacts defines another plane parallel to said plane.

15. The electrical connector as claimed in claim 11, wherein each of said signal and power contacts defines a tail section, and the tail section of the signal contact defines a plane and that of one of said pair of power contacts defines another plane perpendicular to said plane.

16. The electrical connector as claimed in claim 11, where the whole signal contact is located in a plane.

17. An electrical connector comprising:
an insulative housing defining a mating cavity extending in a front-to-back direction;
upper and lower rows of contacts disposed in the housing with front mating portions extending into the mating cavity and rear tail portions extending out of the housing;
all mating portions defining a first set of corresponding planes parallel to one another;
tail portions of the contacts in said upper row defining a second set of corresponding planes parallel to one another;
tail portions of the contacts in said lower row defining a third set of corresponding planes parallel to one another; wherein
the second set of planes are perpendicular to the third set of planes.

18. The electrical connector as claimed in claim 17, wherein one set of said second and third sets of planes extend in compliance with said front-to-back direction.

19. The electrical connector as claimed in claim 17, wherein said first, second and third sets of the planes extend perpendicular to one another.
